(19) United States
(12) Patent Application Publication
(10) Pub. No.: US 2020/0331039 A1
(43) Pub. Date: Oct. 22, 2020

(54) CLEANING METHOD AND CLEANING APPARATUS

(71) Applicant: SUGINO MACHINE LIMITED, Uozu City (JP)

(72) Inventors: Masanori NAKAGAWA, Itasca, IL (US); Don REEDER, Itasca, IL (US)

(21) Appl. No.: 16/720,326

(22) Filed: Dec. 19, 2019

Related U.S. Application Data
(60) Provisional application No. 62/834,607, filed on Apr. 16, 2019.

(51) Int. Cl. B08B 9/00

(52) U.S. Cl. CPC B08B 9/00; B08B 2203/02

(57) ABSTRACT

The present invention provides a cleaning method and a cleaning apparatus capable of omitting cleaning of a target portion that does not need to be cleaned.

The object is cleaned by scanning the structure of the object by transmitting a particle beam through the object, extracting a foreign matter by comparing the obtained scan data of the structure of the object with a 3D model of the object, specifying the cleaning portion that is a target portion including the foreign matter, and executing a partial program for cleaning the cleaning portion from the entire program for cleaning all the target portions

### CROSS-REFERENCE TO RELATED APPLICATIONS

This application claims the benefit of priority to U.S. Provisional Application No. 62/834,607, filed on Apr. 16,2019, the entire contents of which are hereby incorporated by reference.

### BACKGROUND

### 1. Technical Field

The present invention relates to a cleaning method and a cleaning apparatus.

### 2. Description of the Background

A cleaning apparatus including a cleaning chamber, a turret device in which a plurality of nozzles are arranged, and a moving device for driving the turret device has been proposed (for example, Japanese Patent No. 6147623, hereinafter, Patent Literature 1). In the case of cleaning using the cleaning apparatus of Patent Literature 1, the cleaning liquid is ejected from the nozzle, and a jet sequentially collides with all the target portions of an object.

### BRIEF SUMMARY

Only small number of target portions may contain a foreign matter. In addition, the cleaning time becomes longer when the jet collides with all the target portions.

The present invention provides a cleaning method and a cleaning apparatus capable of omitting the cleaning of a target portion that does not need to be cleaned.

A first aspect of the present invention is a cleaning method of an object, including:

scanning a structure of the object by transmitting a particle beam through the object;

extracting a foreign matter by comparing an obtained scan data of the structure of the object with a 3D model of the object;

specifying a cleaning portion that is a target portion including the foreign matter; and

cleaning the object by executing a partial program for cleaning the cleaning portion among an entire program for cleaning all the target portions.

A second aspect of the present invention is a cleaning apparatus, including:

a scanner configured to obtain scan data of a structure of an object by transmitting a particle beam through the object with foreign matter;

a cleaning chamber;

a nozzle arranged in the cleaning chamber, the nozzle configured to move with respect to the object; and

a control device including,
a storage device configured to store
   a 3D model having a target portion and a label associated with the target portion, and
   an entire program including a partial program affixed the label, and an arithmetic device including
a comparison unit configured to compare the scan data with the 3D model to extract the foreign matter,
a cleaning portion specifying unit configured to specify the label associated with cleaning portion that is the target portion having the foreign matter,
a program creating unit configured to read out the partial programs associated with the label among the entire program to create a cleaning program by arranging the partial programs in description order of the entire program, and
a numerical control unit configured to numerically control the nozzle with respect to the object based on the cleaning program.

Cleaning includes cleaning and deburring. The particle beam includes an electromagnetic wave and a neutron beam. The electromagnetic wave is, for example, an X-ray or a γ-ray. The scanner is, for example, an X-ray CT scanner, a γ-ray CT scanner, or a neutron beam CT scanner. The foreign matter is, for example, chips, cutting burrs, fiber scraps, or abrasives.

The object is a mechanical part after machining or before assembly. The object may be, for example, a cylinder head, a cylinder block, a crankshaft, a transaxle case, a transaxle housing, a valve body, a pump body, or an ABS body. The object includes a structure such as a water hole, an oil hole, an internal thread, a through hole, a pin hole, an oil passage, a crank chamber, a cam chamber, and a boss. Among these structures, a portion to be cleaned by colliding with a jet of cleaning liquid is referred to as a target portion.

The cleaning apparatus may include a cleaner and a scanner. The cleaner may include a high-pressure cleaner and a low-pressure cleaner. For example, the high-pressure cleaner ejects a jet to collide with a target portion only in which a foreign matter of a target object is found, and the low-pressure cleaner ejects a jet to collide with a surface of the target object or a target portion in which a foreign matter is not found.

The cleaning apparatus may include a pump or a tank. The tank stores a cleaning liquid. The pump pressurizes and dispenses the cleaning liquid. The pump is, for example, a piston pump, a gear pump, or a centrifugal pump. The discharge pressure of the pump is preferably between 5 and 200 MPa.

The cleaning apparatus may have a moving device and fixed nozzle. The moving device may move the object with respect to the fixed nozzle.

The 3D model is a stereoscopic model of the object in reference dimensions, and includes the target portion and the label. One or more labels are affixed to each target portion. The 3D models may include a plurality of components and may include material data.

The entire program, the partial program and the cleaning program are numerically controlled programs. The entire program is a program for cleaning all target portions of the object. The entire program includes partial programs and has a layer structure. The lower layer partial program is associated with the middle layer partial program. The middle layer partial program is associated with the upper layer partial program. The label is affixed to each partial program.

The partial program includes a nozzle selection section, a retraction section, or a cleaning target portion section relating to the target portion. Each cleaning target portion section includes an associated nozzle selection section and a retraction section. The partial program may include a header portion and a footer portion.

The entire program may be an aggregate of sub-programs.

The entire program may include a partial program related to the target portion (essential cleaning portion) to be cleaned without fail, and a partial program related to the target portion (selective cleaning portion) to be cleaned selectively.

The label associates the cleaning target portion section of the partial program with the target portion. The label is associated with the cleaning target portion section. One or more labels are associated with one target portion. The labels may include a combination order or associations between partial programs. The label may be a program number.

The comparison unit extracts a target portion to be cleaned for each object from the scan data. The scan data includes, for example, the structure of a casting defect, a machining error, a foreign matter, and a burr, depending on the processing history of the object. The machining error is, for example, a position error, a cylindricity, a total run-out, or a dimension error. Burrs and foreign matter appear in the data as unique protrusions. Further, the foreign matter is sometimes detected as a difference in material from the material. The machining error appears as parallel moving or inclination of a hole or an entire surface, or vibration of the surface. Therefore, the comparison unit performs overall comparison and individual evaluation.

For example, a comparison of cylindrical holes will be described. The center of gravity of the scanning model is compared with the center of gravity of the 3D model for the cylindrical bore position. The center of gravity may extract a plurality of positions with respect to the depth of the hole. The displacement of the center of gravity position is detected as a position error. Furthermore, the center of gravity of the cylindrical hole in the scanning model is superimposed on the cylindrical hole in the 3D model to obtain a partial difference. When the amount of displacement from the 3D model continuously changes and the inclination of the amount of displacement with respect to the length along the surfaces of the 3D model of the amount of displacement does not exceed the thresholds, the displacement part is determined as a cylindrical error. Differences in other structures are determined as foreign matter.

The comparison unit may extract only the foreign matter whose evaluation value is equal to or larger than the threshold value. The evaluation value is a measurement value of the foreign matter, and is, for example, a major axis dimension or a volume. The major axis dimension is a dimension in which the longest distance between two points determined on the surface of the foreign matter. The threshold value is an evaluation value of the foreign matter in which no residual is observed after cleaning.

The program creation unit reads out a partial program related to the label affixed to the target portion to be cleaned, from the entire program. The program creation unit creates a cleaning program by configuring the read partial programs. The order in which the partial programs are combined is given as labels or rank data. At this time, a header portion or a footer portion may be added.

The program creation unit may add an essential cleaning unit to the cleaning program.

When skipping the unnecessary partial programs among the entire program, the cleaning program need not be created.

All objects introduced into the cleaning apparatus are examined by scanner. As a result of the inspection, a cleaning program including only the target portion including the found foreign matter and the essential cleaning portion is created for each object. The cleaning apparatus cleans the object based on the created individual cleaning program.

According to the present invention, a cleaning method and a cleaning apparatus capable of omitting cleaning of a target portion that does not need to be cleaned are provided.

### BRIEF DESCRIPTION OF DRAWINGS

FIG. 1 shows a cleaning apparatus of an embodiment.

FIG. 2 shows a control device of the embodiment.

FIG. 3 shows a 3D models of the embodiment.

FIG. 4 shows an entire program of the embodiment.

FIG. 5 shows the nozzle path of the entire program of the embodiment.

FIG. 6 shows the nozzle path of the retraction section of the embodiment.

FIG. 7 is a flow chart showing a cleaning method of the embodiment.

FIG. 8 shows the results of the model comparison of the embodiment.

FIG 9 shows a cleaning program of the embodiment.

FIG. 10 shows a cleaning path of the embodiment.

### DETAILED DESCRIPTION

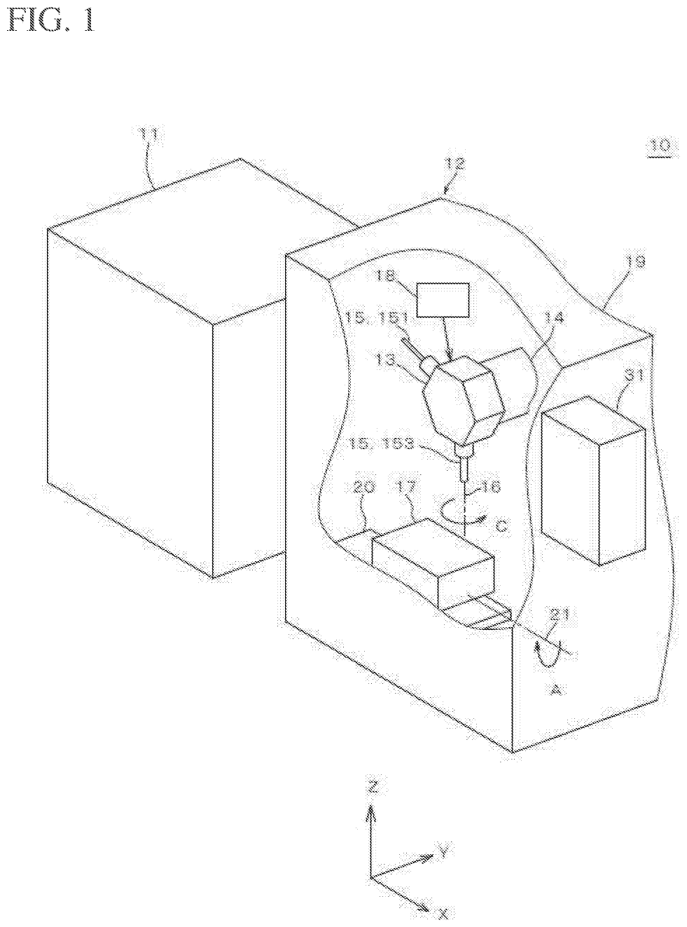

As shown in FIG. 1, a cleaning apparatus 10 according to an embodiment includes an X-ray CT scanner 11 (hereinafter referred to as “scanner”), a cleaning machine 12, and a control device 31. The cleaning machine 12 includes a cleaning chamber 19, a pump 18, and a nozzle 15. The cleaning machine 12 may include a turret 13 and a moving device 14. The nozzle 15 is, for example, a straight jet nozzle 151 or an L-type nozzle 153.

The cleaning machine 12 causes a jet 47 from the nozzle 15 to collide with an object 17, and clean or deburr the object 17. For example, U.S. Pat. Nos. 9,364,869, 9,393,627, and 9,630,217 have been proposed as the cleaning machine 12. The cleaning machine 12 is sold as the JCC series by Sugino Machine Limited.

The cleaning table 20 is located in the cleaning chamber 19. The cleaning table 20 may be swingable about a rotation axis 21 parallel to the X-axis direction. The cleaning table 20 positions and fixes the object 17 at a predetermined position.

The pump 18 pressurizes the cleaning liquid from a cleaning liquid tank (not shown) and supplies the cleaning liquid to the nozzle 15 via the turret 13.

The moving device 14 freely moves the turret 13 and the nozzle 15 in the left-right direction (X-axis direction), the front-rear direction (Y-axis direction), and the vertical direction (Z-axis direction) with respect to the cleaning table 20.

The turret 13 is mounted on the moving device 14. The turret 13 has a rotation axis 16 parallel to the Z-axis. A plurality of nozzles 15 may be attached to the turret 13. The turret 13 turns to index a single nozzle 15 downwardly. The turret 13 supplies the cleaning liquid to the downwardly indexed nozzle 15.

Preferably, the downwardly indexed nozzle 15 can rotate about a rotation axis 16 or can be positioned in a rotational direction.

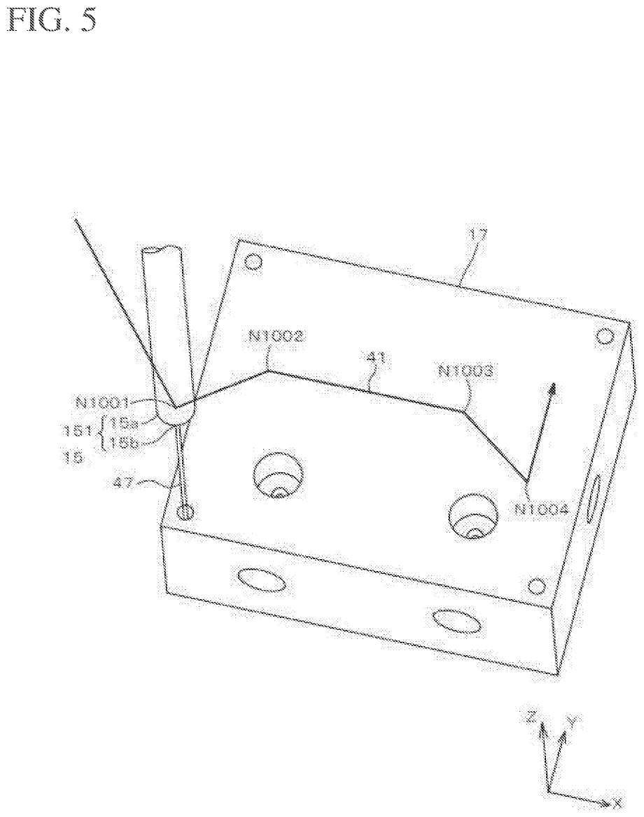

As shown in FIG. 5, the straight injection nozzle 151 has a shaft body 15a and a nozzle hole 15b. The shaft body 15a extends along the rotation axis 16. The nozzle hole 15b is disposed at the distal end of the shaft body 15a on the rotation axis 16. The nozzle hole 15b generates a jet 47 along the rotation axis 16.

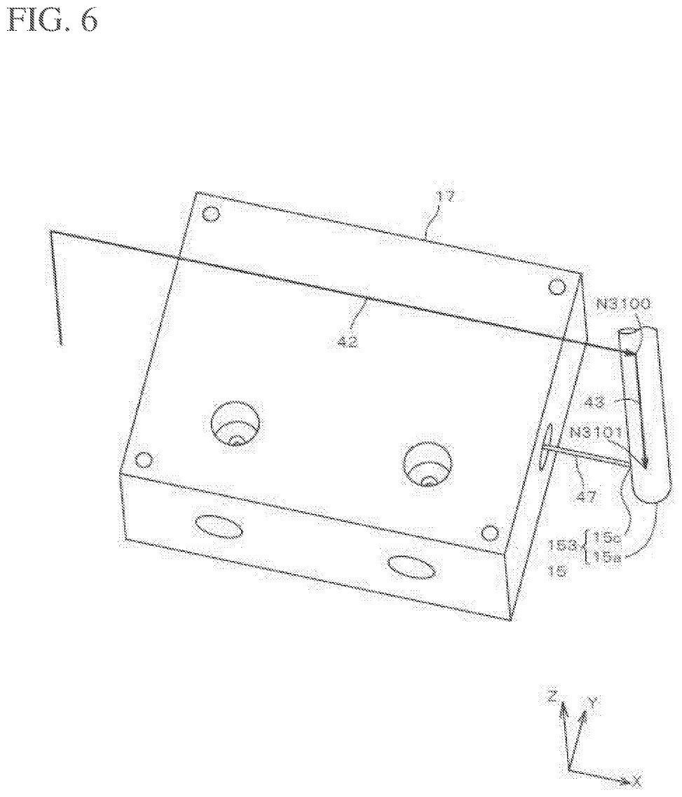

As shown in FIG. 6. the L-type nozzle 153 has a shaft body 15a and a nozzle hole 15c. The nozzle hole 15c is disposed at the distal end of the shaft body 15a, directing perpendicular to the rotation axis 16. The nozzle hole 15c generates a jet 47 in a direction perpendicular to the rotation axis 16.

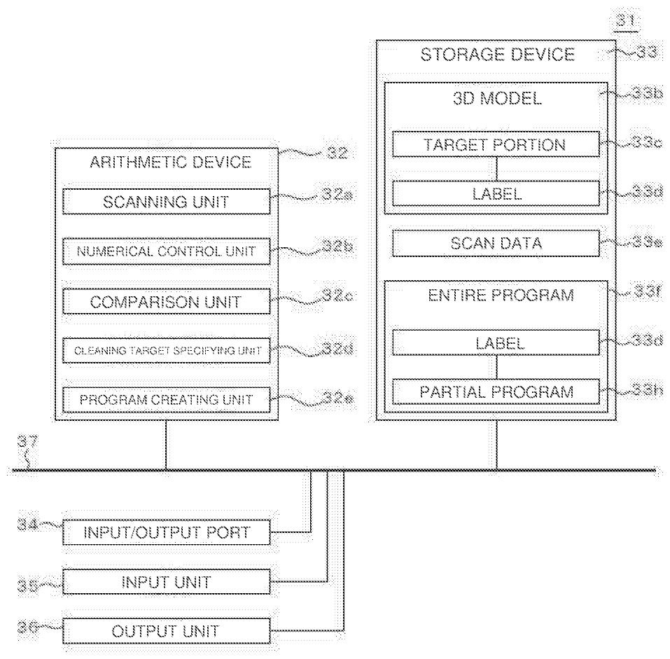

As shown in FIG 2, the control device 31 includes an arithmetic device 32, a storage device 33, an input/output port 34, an input unit 35, an output unit 36, and a bus 37. The bus 37 communicably connects the arithmetic device 32, the storage device 33, the input/output port 34, the input unit 35, and the output unit 36.

The storage device 33 may include a main storage device or an external storage device. The storage device 33 stores the 3D model 33b, the scan data 33e, and the entire program 33f.

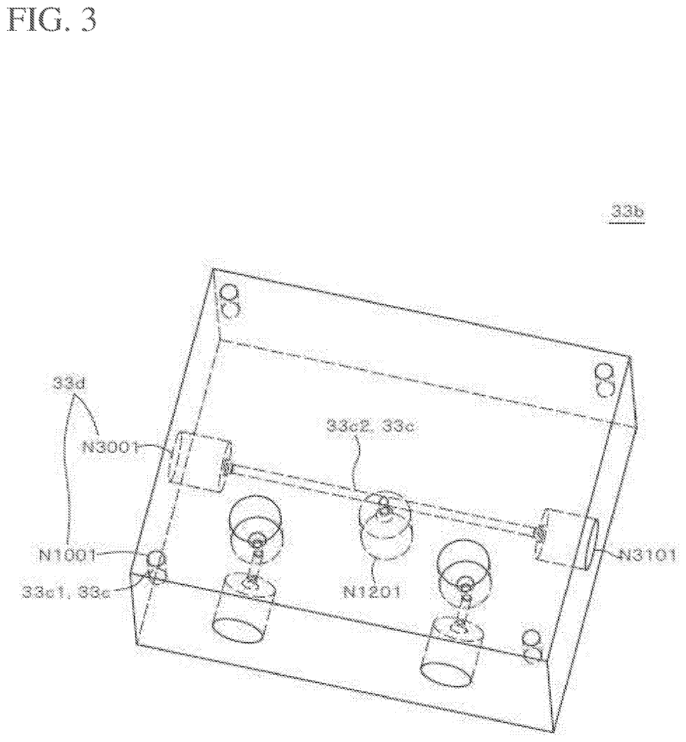

As shown in FIG. 3, the 3D model 33b includes a plurality of target portions 33c. The same number of labels 33d as the number of partial programs 33h for cleaning each target portion 33c are affixed to the target portion 33c. A single label N1001 is affixed to the target portion 33c1. Three labels N1201, N3001, N3101 are affixed to the target portion 33c2.

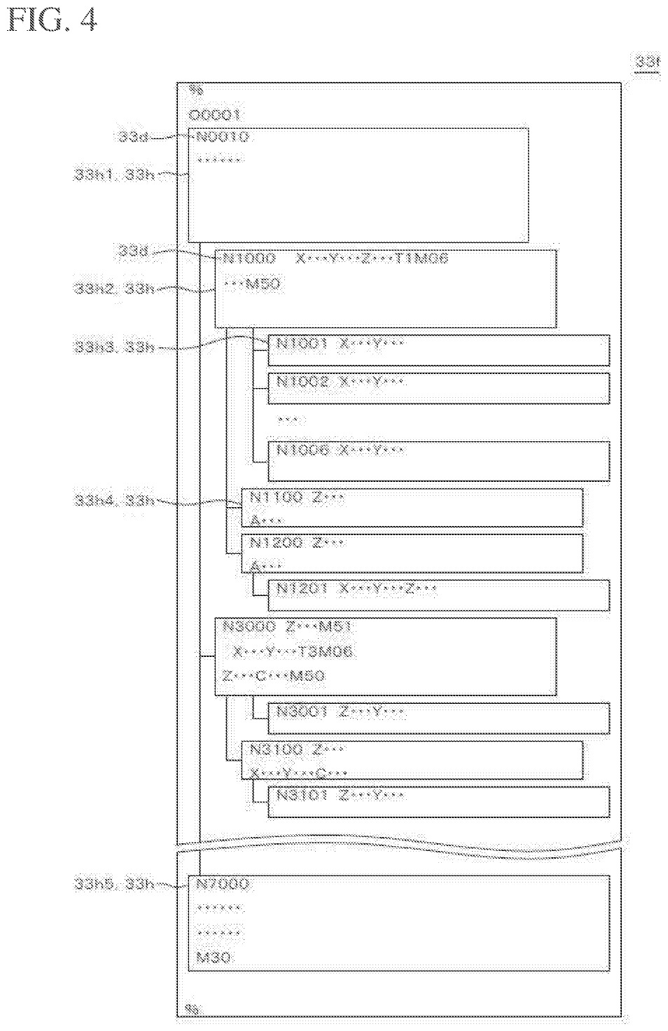

As shown in FIG. 4, the entire program includes a label 33d and a partial program 33h associated with the label 33d. The partial program 33h includes, for example, a header portion 33h1, a nozzle selection section 33h2, a cleaning target portion section 33h3, a retraction section 33h4, and a footer portion 33h5. Each partial program 33h is provided with a label 33d.

The nozzle selection section 33h2 may be omitted when the cleaning machine 12 has only one nozzle 15.

As shown in FIG. 5, by operating the entire program 33f, all the target portions 33c are cleaned. The trajectory 41 indicates a trajectory of the nozzle 151.

The M code and T code are as follows.

M06: Nozzle selection

M50: Start injection

M51: Stop injection

M30: End of block

T1: Select Straight injection nozzle

T3: Select L-type nozzle

The header portion 33h1 includes instructions for substitution of a numerical value into a function parameter or a coordinate system, initial setting of a G code, or, a preparation operation such as closing of a door, clamping, and operation of a pump.

The nozzle selection section 33h2 includes preparation operations such as retraction for rotating the turret 13, nozzle selection, and starting injection. The nozzle selection section 33h2 belongs to an upper layer.

The cleaning target portion section 33h3 indicates a path of the nozzle for each target portion. For example, in the case of a hole, the path to the opening of the hole is described for each nozzle. The cleaning target portion section 33h3 belongs to a lower layer.

The retraction section 33h4 indicates a path along which the nozzle 15 is retracted. The retraction section 33h4 is inserted between the several cleaning target portion sections 33h3. In other words, when the nozzle 15 interferes with the object 17 or the cleaning machine 12 by directly connecting the cleaning target portion section 33h3 before and after the retraction section 33h4, the retraction section 33h4 is inserted therebetween so that the nozzle 15 does not interfere with the object 17 or the cleaning machine 12. The retraction section 33h4 is, for example, a gate motion or a table rotation operation. The retraction section 33h4 belongs to the middle layer.

FIG. 6 shows an exemplary trajectory (gate-motion) 42 of the retraction section 33h4 to which label N3100 is affixed. The L-type nozzle 153 causes the jet 47 to collide with the target portion 33c2 from the opening on the X− side. At this time, the L-type nozzle 153 is located on the X− side of the object 17. The trajectory 42 shows that the L-type nozzle 153 moves upward in the Z direction, and then moves to the X+ side of the object 17 on the X-Y plane. Thereafter, the L-type nozzle 153 is moved so that the jet 47 is ejected from the X+ side. At this time, the L-type nozzle 153 moves upward in the Z direction, and thus does not interfere with the object 17.

The footer portion 33h5 includes instructions of a stop operation such as an origin return operation, door opening, unclamping, pump stopping, and the like.

For example, the label 33d is numbered with the associated nozzle number (T code) as a thousands place digit, the associated retraction part arrangement order as a hundreds place digit, and the pair of cleaning target portion section 33h3 associated with the nozzle selection part 33h2 or the retraction section 33h4 as the last two digits. For example, in the entire program 33f, the processing order of the programs is determined in ascending order of labels.

The input/output port 34 is connected to the moving device 14 and the pump 18.

The input unit 35 is, for example, a keyboard or a pointing device. The input unit 35 may be a software keyboard or touch panel. The output unit 36 is, for example, a monitor.

The arithmetic device 32 includes a scanning unit 32a, a numerical control unit 32b, a comparison unit 32c, a cleaning portion specifying unit 32d, and a program creating unit 32e.

A scanning unit 32a controls the scanner 11.

The numerical control unit 32b numerically controls the moving device 14. The numerical control unit 32b controls the pump 18 and the turret 13 in accordance with the cleaning program.

The comparison unit 32c compares the scan data 33e with the 3D model 33b, and extracts the foreign matter 33i included in the scan data 33e.

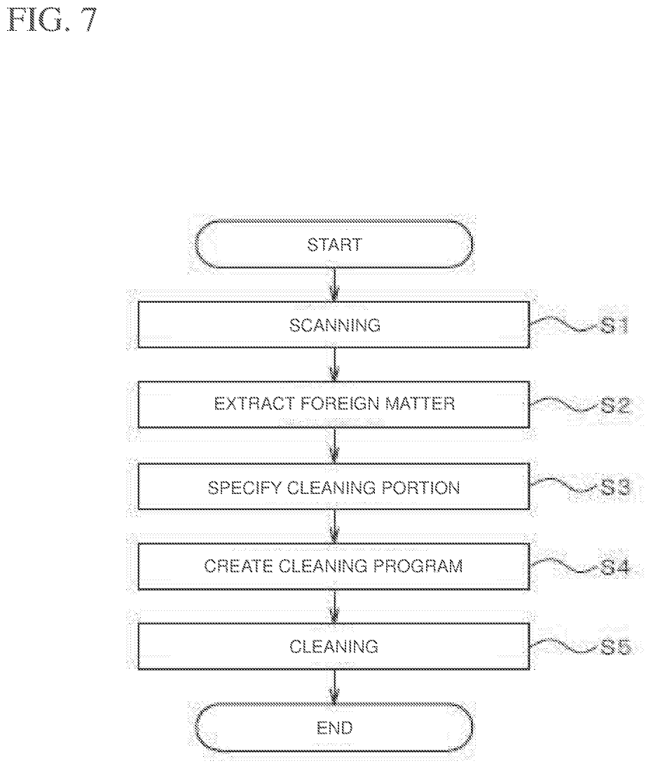

Referring to FIG. 7, a cleaning method will be described. In step S1, the scanner 11 scans the object 17 by transmitting a particle beam through the object 17. The scanning unit 32a obtains scan data 33e including the structure of the object 17.

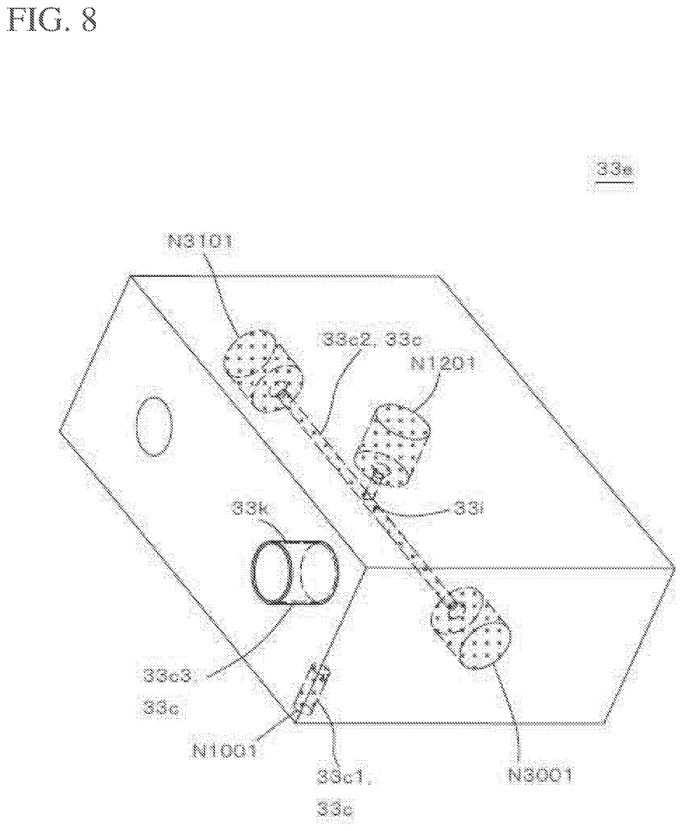

As shown in FIG. 8. in step S2, the comparison unit 32c compares the scan data 33e with the 3D model 33b to extract foreign matter from the scan data 33e. The comparison unit 32c defines the specific structures inside the target portion 33c1 and the target portion 33c2 as the foreign matter 33i. The comparison unit 32c defines a machining error (excessive diameter) 33k with respect to the target portion 33c3.

In step S3, the cleaning portion specifying unit 32d specifies the target portions 33c1 and 33c2 including the extracted foreign matter 33i as cleaning portions. Then, the cleaning portion specifying unit 32d sends the labels N1001, N1201, N3001, N3101 associated with the cleaning points to the program creating unit 32e.

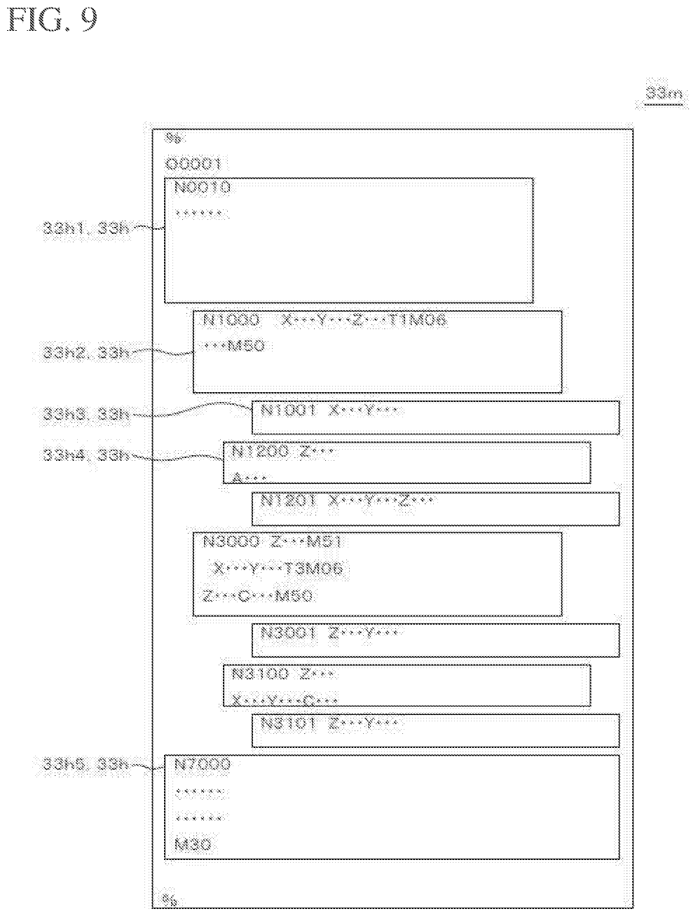

Referring to FIGS. 4, 8, and 9, in step S4, the program creating unit 32e creates a cleaning program 33m based on the entire program 33f and the specified cleaning portion.

The partial program 33h related to the cleaning place is indicated by labels as follows.

33c1: N100l, N1000

33c2: N3001, N3101, N3100, N3000

The nozzle selection section 33h2 to which the label N1000 is affixed is associated with the upper layer of the cleaning target portion section 33h3 to which the label N1001 is affixed. The retraction portion 33h4 to which the label N3100 is affixed is associated with an upper layer of the cleaning target portion section 33h3 to which the label N3101 is affixed. The nozzle selection section 33h2 to which the label N3000 is affixed is associated with the upper layer of the labels N3001 and N3100.

The program creating unit 32e adds the header portion 33h1 (label: N0010) and the footer portion 33h5 (label: N7000) to the above-described partial program 33h to form the cleaning program 33m. The program creating unit 32e arranges the partial programs 33h in the describing order of the entire program 33f, that is, in ascending order of labels, to form the cleaning program 33m.

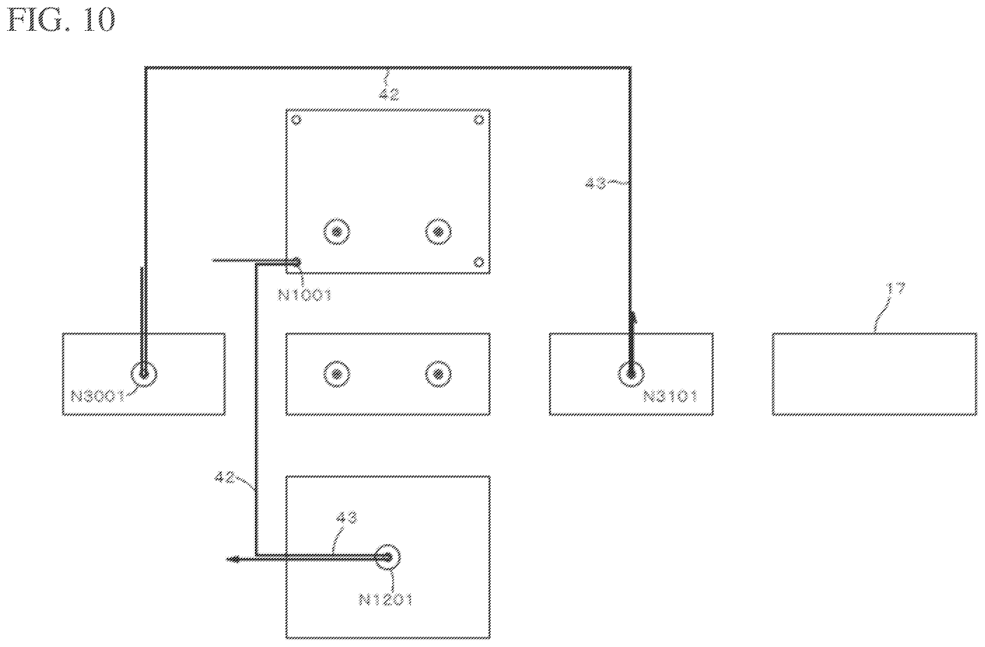

As shown in FIG. 10, in step S5, the cleaning machine 12 executes the cleaning program 33m to clean the object 17. FIG. 10 shows the trajectories 42 to 43 of the nozzles 151, 153 on an orthogonal view of the object 17 according to the third angle projection. The nozzles 151 and 153 clean only the target portions 33c1 and 33c2.

It should be noted that the present invention is not limited to the above-mentioned embodiments, and various modifications may be made without departing from the gist of the present invention, and all technical matters included in the technical idea described in the claims are the subject matter of the present invention. While the foregoing embodiments illustrate preferred examples, those skilled in the art will appreciate that various alternatives, modifications, variations, or improvements may be made in light of the teachings herein and are within the scope of the appended claims.

### REFERENCE SIGNS LIST

10 Cleaning apparatus

11 Scanner

15, 151, 153 Nozzle

17 Object

19 Cleaning chamber

31 Control device

33f Entire program

33h2 Nozzle selection section

33h3 Cleaning target portion section

33h4 Retraction section

33i Foreign matter

33m Cleaning program

What is claimed is:

1. A cleaning method of an object, comprising:
scanning a structure of the object by transmitting a particle beam through the object;
extracting a foreign matter by comparing an obtained scan data of the structure of the object with a 3D model of the object;
specifying a cleaning portion that is a target portion including the foreign matter; and
cleaning the object by executing a partial program for cleaning the cleaning portion among an entire program for cleaning all the target portions.

2. The cleaning method according to claim 1, further comprising:
reading, among the entire program,
a retraction section associated with the cleaning portion for avoiding that a nozzle interferes with a cleaning machine or the object, and
a cleaning target portion section associated with a cleaning of the cleaning portion; and
creating a cleaning program by combining the read retraction section and the read cleaning target portion section.

3. The cleaning method according to claim 2, further comprising:
reading a label associated with the cleaning portion; and
creating the cleaning program by arranging the cleaning target portion section affixed the read label and the retraction section associated with an upper layer of the read label in a describing order of the entire program.

4. The cleaning method according to claim 2, further comprising:
reading, among the entire program, a nozzle selection section corresponding to the cleaning portion; and
creating a cleaning program by combining the read nozzle selection section, the read retraction section and the read cleaning target portion section.

5. The cleaning method according to claim 4, further comprising:
creating the cleaning program by arranging the nozzle selection section associated with an upper layer of the read label, the cleaning target portion section affixed the read label, and the retraction section associated with an upper layer of the read label in a describing order of the entire program.

6. The cleaning method according to claim 1, further comprising:
comparing the scan data with the 3D model to extract a difference of structure other than machining error as the foreign matter.

7. The cleaning method according to claim 1, further comprising:
extracting the foreign matter having a greater dimension than a predetermined threshold value.

8. The cleaning method according to claim 3, further comprising:
reading, among the entire program, a nozzle selection section corresponding to the cleaning portion; and
creating a cleaning program by combining the read nozzle selection section, the read retraction section and the read cleaning target portion section.

9. The cleaning method according to claim 8, further comprising:
creating the cleaning program by arranging the nozzle selection section associated with an upper layer of the read label, the cleaning target portion section affixed the read label, and the retraction section associated with an upper layer of the read label in a describing order of the entire program.

10. The cleaning method according to claim 2, further comprising:
comparing the scan data with the 3D model to extract a difference of structure other than machining error as the foreign matter.

11. The cleaning method according to claim 3, further comprising:
comparing the scan data with the 3D model to extract a difference of structure other than machining error as the foreign matter.

12. The cleaning method according to claim 4, further comprising:
comparing the scan data with the 3D model to extract a difference of structure other than machining error as the foreign matter.

13. The cleaning method according to claim 5, further comprising:
comparing the scan data with the 3D model to extract a difference of structure other than machining error as the foreign matter.

14. The cleaning method according to claim 2, further comprising:
extracting the foreign matter having a greater dimension than a predetermined threshold value.

15. The cleaning method according to claim 3, further comprising:
extracting the foreign matter having a greater dimension than a predetermined threshold value.

16. The cleaning method according to claim 4, further comprising:
extracting the foreign matter having a greater dimension than a predetermined threshold value.

17. The cleaning method according to claim 5, further comprising:
extracting the foreign matter having a greater dimension than a predetermined threshold value.

18. The cleaning method according to claim 6, further comprising:
extracting the foreign matter having a greater dimension than a predetermined threshold value.

19. A cleaning apparatus, comprising:
a scanner configured to obtain scan data of a structure of an object by transmitting a particle beam through the object with foreign matter;
a cleaning chamber;
a nozzle arranged in the cleaning chamber, the nozzle configured to move with respect to the object; and
a control device including,
a storage device configured to store
a 3D model having a target portion and a label associated with the target portion, and
an entire program including a partial program affixed the label, and an arithmetic device including
a comparison unit configured to compare the scan data with the 3D model to extract the foreign matter,
a cleaning portion specifying unit configured to specify the label associated with cleaning portion that is the target portion having the foreign matter,
a program creating unit configured to read out the partial programs associated with the label among the entire program to create a cleaning program by arranging the partial programs in description order of the entire program, and
a numerical control unit configured to numerically control the nozzle with respect to the object based on the cleaning program.

20. The cleaning apparatus according to claim 19, wherein
the partial program includes
a nozzle selection section corresponding to the cleaning portion, the nozzle selection section positioned in upper layer,
a retraction section associated with the cleaning portion for avoiding that the nozzle interferes with a cleaning machine or the object, the retraction section positioned in middle layer, and
a cleaning target portion section for cleaning the cleaning portion, the cleaning target portion section positioned in lower layer, the cleaning target portion section associated with the nozzle selection section or the cleaning target portion section.
